(19) United States
(12) Patent Application Publication
(10) Pub. No.: US 2025/0192257 A1
(43) Pub. Date: Jun. 12, 2025

(54) Battery Unit

(71) Applicant: Robert Bosch GmbH, Stuttgart (DE)

(72) Inventors: Florian Kneer, Duernau (DE); Josef Baumgartner, Wildberg (DE); Tina Ringshandl, Ulm (DE)

(21) Appl. No.: 18/967,252

(22) Filed: Dec. 3, 2024

(30) Foreign Application Priority Data
Dec. 7, 2023 (DE) 10 2023 212 358.4

(51) Int. Cl. H01M 10/48; H01M 50/24; H01M 50/284

(52) U.S. Cl. CPC H01M 10/488; H01M 50/24; H01M 50/284

(57) ABSTRACT

A battery unit includes (i) a circuit board element, (ii) a lighting element which is configured to display a charge state of the battery unit, (iii) a light guiding element, and (iv) a button element. The lighting element is arranged on the circuit board element. The light guiding element is in contact with the lighting element to guide a beam of light emanating from the lighting element. The button element is arranged on the circuit board element. The light guiding element is configured to guide a force that acts on the light guiding element, to the button element, by way of changing the shape of the light guiding element.

This application claims priority under 35 U.S.C. § 119 to patent application no. DE 10 2023 212 358.4, filed on Dec. 7, 2023 in Germany, the disclosure of which is incorporated herein by reference in its entirety.

The present disclosure relates to a battery unit, a method for manufacturing a battery unit, and the use of a battery unit.

### BACKGROUND

Currently, there are a variety of different solutions for forming housing components of battery units. Due to the increasing number of usage scenarios for batteries as well as the increased requirements for comfort, the demand for innovative and robust battery units is continuously increasing.

The continuous weight reduction in the tool sector for increasing comfort as well as the increasing competition create cost pressure so that more cost-effective and more efficient components for tools are more in demand.

### SUMMARY

The battery unit according to the disclosure with the features described below has the advantage over the known units that the light guiding element and the cover of the button can be formed in one piece to thus increase the robustness of the battery unit as well as decrease the cost of manufacture. In particular, cost advantages can arise due to the fact that the light guiding element of the battery unit can be produced by way of a 1K or 2K component injection molding process. This can in particular lead to a simplified assembly of the light guiding element as well as the battery unit. The robustness of the battery packs can in particular be increased and, thus, the quality can be improved and the customer comfort can be increased. By integrating the function of light guiding and actuation, a more sustainable product can be realized by conserving resources in injection molding as well as by saving material and energy in the injection molding process. Further preferably, increased sealing can be achieved by the light guiding element in conjunction with the housing of the battery unit, so that more inexpensive electronic components can be used, for example, in order to be able to dispense with components with high requirements for fluid sealing or the like.

According to the present disclosure, this is achieved by the battery unit comprising a circuit board element. Furthermore, the battery unit comprises a lighting element that is configured to indicate a charge state of the battery unit. In addition, the battery unit comprises a light guiding element and a button element. The lighting element is arranged on the circuit board element. The light guiding element is in contact with the lighting element to guide a beam of light starting from the lighting element, wherein the button element is arranged on the circuit board element. In addition, the light guiding element is configured to guide a force acting on the light guiding element to the button element by way of changing the shape of the light guiding element.

In other words, the light guiding element assumes two functions to transport light beams from the lighting element to an outer skin of the battery unit and to form a flexible cover for the button. The battery unit can in particular comprise a circuit board element on which the lighting element is arranged. Further preferably, all other components of the battery unit may also be arranged on the circuit board element, for example a battery management system or a charging module. Further preferably, the lighting element may comprise a plurality of light emitting diodes or a plurality of lighting elements may be arranged on the circuit board element to thus indicate the charge state of the battery unit when the button element is actuated. In particular, the light guiding element can transport light beams provided by the lighting element from an internal space of the battery unit to an external surface of the battery unit. This may be done by way of a plastic, such as polycarbonate. However, the light guiding element can in particular comprise at least one further material and/or comprise a geometry which at least partially deflects the light guiding element so that a force acting on the light guiding element can be guided to the button element. Further, preferably, ribs or protrusions or the like may transport the light from the lighting element, for example an LED, to a desired position on the external surface of the housing of the battery unit. The interior of the housing of the battery unit in particular can thus be protected from environmental factors such as dust, moisture or the like.

Further preferred developments are described below.

Preferably, the light guiding element is configured to actuate the button element at a predetermined force.

An advantage of this embodiment is that the light guiding element can be designed, by way of material selection or geometry, in such a way that the button element is triggered at a certain force, in order to thus avoid accidental activation of the button element as far as possible.

Preferably, the battery unit comprises a housing element, wherein the light guiding element is configured to form a substantially fluid-tight and/or particulate-tight connection with the housing element.

An advantage of this embodiment is that electronic components inside the battery unit are protected from environmental factors such as moisture and/or dust. In this context in particular, substantially fluid-tight and/or particulate-tight can mean that a volume flow of fluids as well as particles can in particular be reduced by at least 50%.

Preferably, the housing element, the button element and/or the light guiding element comprise a stop element, wherein the stop element is configured to limit the pre-change of the light guiding element.

An advantage of this embodiment is that, with an increased force on the light guiding element, it may not break off or a breakage is prevented, and thus the longevity of the battery unit can be significantly increased.

Further preferably, the light guiding element comprises at least one bar, which engages with a recess of the housing element.

An advantage of this embodiment is that by way of a bar and a recess of the housing element, an interlocking connection is formed between the light guiding element and the housing in order to thus in particular provide the substantially fluid-tight and/or particulate-tight connection. The light guiding element can in particular comprise a bar, a rib or the like, which has a round or square cross-section in order to be able to thus engage a recess on the housing or the like.

Preferably, the bar abuts the lighting element.

An advantage of this embodiment is that the bar is configured so that light beams can be transported from the lighting element to the outer surface of the battery unit, in order to thus be able to substantially prevent a scattering effect of light rays from one lighting element to another lighting element.

Further preferably, the light guiding element comprises a further bar, wherein the further bar has a lower longitudinal extension direction than the bar, such that the light guiding element is insertable between the lighting element and the housing element.

An advantage of this embodiment is that the light guiding element can be better adapted to the available design space, because the different bar heights allow the light guiding element to be inserted laterally.

Preferably, the light guiding element comprises a first segment and a second segment, wherein the first segment abuts the button element and the housing element, wherein the second segment is configured to provide a deflection of the first segment.

An advantage of this embodiment is that, by the reduced deflection as well as by the functional distribution between the first segment and the second segment, excess pressure on the button element can be prevented and the force applied to the circuit board element can be reduced.

Preferably, the second segment has a curved longitudinal extension direction to provide a spring effect for the first segment.

An advantage of this embodiment is that excess loading energy can be dampened by way of the curved longitudinal extension direction of the second segment or by the curved geometry, and thus the operating duration of the battery unit can be further increased.

Further preferably, the light guiding element comprises a first and a second section, wherein the first section is located at least partially over the button element, wherein the second section is located at least partially over the lighting element, wherein only the first section is configured to provide the shape change of the light guiding element.

An advantage of this embodiment is that the second section is arranged substantially in a stationary manner on the lighting element and thus the sealing of the lighting elements is further increased, wherein, at the same time, the necessary flexibility is provided in the first section to be able to activate the button element.

Preferably, the first section comprises a first material having a first modulus of elasticity, wherein the second section comprises a second material having a second modulus of elasticity, wherein the first section and the second section are formed in one piece.

An advantage of this embodiment is that the properties of the first section and the second section can be adjusted with the different materials. For example, the first section comprises a material that is at least partially deformable in order to be able to thus form the cover for the button element. Further preferably, the second section comprises a material that is substantially stiff so as to be able to form an improved sealing effect between the light guiding element and the housing of the battery unit.

Preferably, the first section is deflectable to the second section such that the second section is arranged substantially in a stationary manner with respect to the lighting element and the first section provides the shape change of the light guiding element.

An advantage of this embodiment is that the seal between the light guiding element and the housing of the battery unit can be further increased.

Further preferably, the light guiding element comprises a deflector element arranged between the first section and the second section, wherein the deflector element is configured to deflect the first section towards the second section to provide the shape change of the light guiding element.

An advantage of this embodiment is that with material selection or geometry adjustment of the deflector element, deflection degree or deflection behavior of the first section can be adjusted in a targeted manner.

Preferably, the first section and the second section are arranged with respect to each other such that the first section is configured to provide a pretensioning force against at least one side surface of the battery unit.

An advantage of this embodiment is that by way of the pretensioning force, the amount of liquid as well as dust can be reduced, which can intrude into the housing when the button element is actuated or at rest.

Preferably the circuit board element comprises the lighting element, the button element and a battery management system, in particular all the electronic components of the battery unit.

An advantage of this embodiment is that, by way of functional integration, the manufacturing costs of the battery unit can be further reduced.

Further preferably, the circuit board element has a main extension direction, wherein a plurality of lighting elements is located along the main extension direction to indicate the charge state of the battery unit.

An advantage of this embodiment is that with more lighting elements arranged along the main extension direction, the detectability of the loading state can be significantly improved.

Further preferably, the light guiding element is configured to form at least one ring around the lighting element for guiding the light.

An advantage of this embodiment is that when the light guiding element forms a ring or similar around the lighting element, reflections of the emitted light are also guided to the outer surface of the housing.

A further aspect of the disclosure relates to a method for manufacturing a battery unit as described above and below, comprising the following steps:
providing a light guiding element,
arranging the light guiding element on the battery unit,
   wherein the arrangement forms a substantially fluid-tight and/or particulate-tight connection between the light guiding element and the battery unit, and the light guiding element provides a cover for a button element of the battery unit.

An advantage of this embodiment is that the time for assembling a battery unit can be significantly improved by the fact that the positioning of the light guiding element can provide both the fluid-tight and particulate-tight connection as well as the cover for the button element.

Another aspect of the disclosure relates to the use of a battery unit as described above and described below for power supply.

### BRIEF DESCRIPTION OF THE DRAWINGS

Exemplary embodiments of the disclosure are explained in detail below with reference to the accompanying drawings. The drawing shows:

FIGS. 1 to 5—a battery unit according to one embodiment,

FIG. 6—a flow chart illustrating the steps of the method according to one embodiment, and

FIGS. 7 to 27—a battery unit according to one embodiment.

### DETAILED DESCRIPTION

Preferably, all identical components, elements, and/or units are provided with the same reference symbols in all figures.

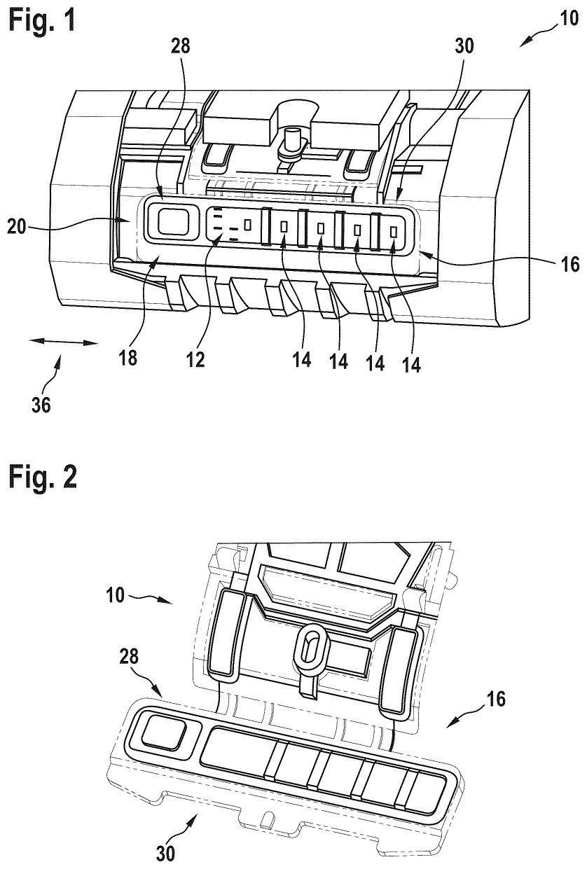

FIG. 1 shows a battery unit 10 according to one embodiment. The battery unit 10 comprises a circuit board element 12. Furthermore, to be able to indicate a charge state of the battery unit 10, lighting elements 14 are arranged on the circuit board element 12. The lighting elements 14 are arranged along a main direction of extension 36 of the battery unit 10. Further preferably, the battery unit 10 comprises a light guiding element 16, which, as shown in FIG. 1, covers the lighting elements 14. Further preferably, the battery unit 10 comprises a button element 18, which, when actuated, indicates the charge state of the battery unit 10. In particular, the light guiding element 16 comprises a first section 28, which is arranged over the button element 18, and a second section 30, which is arranged over the lighting elements 14. Further preferably, the battery unit 10 comprises a housing element 20, wherein the light guiding element 16 provides a substantially fluid-tight and/or particulate-tight connection to the housing element 20, in order to be able to thus protect the lighting elements 14 and the circuit board element 12 from environmental impacts.

FIG. 2 shows a battery unit 10 according to one embodiment. In FIG. 2, the light guiding element 16 of the battery unit 10 is shown. The light guiding element 16 comprises a first section 28 and a second section 30. The first section 28 can be arranged in particular over a button element 18 of the battery unit 10, and the second section 30 can be arranged over a lighting element 14 of the battery unit 10.

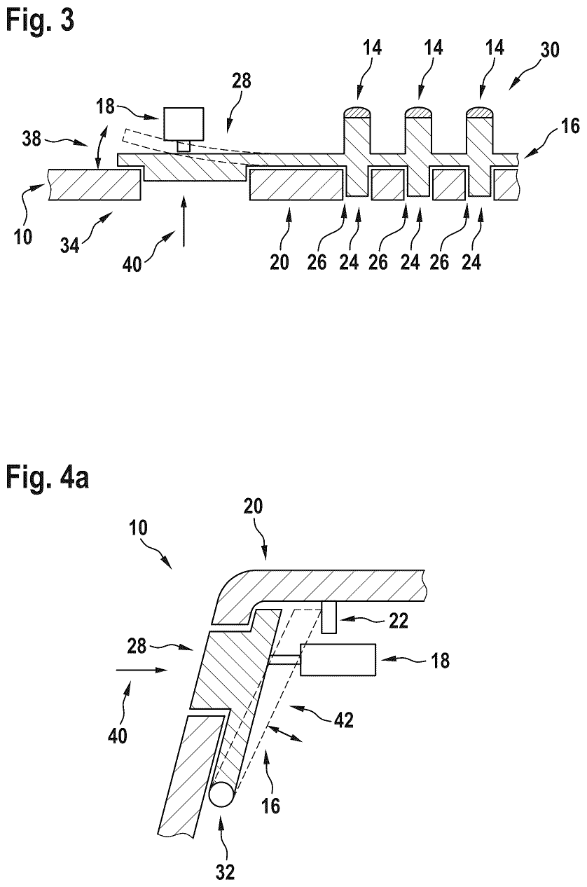

FIG. 3 shows an embodiment of the battery unit according to one embodiment. The battery unit 10 comprises a lighting element 14. A light guiding element 16 abuts the lighting element 14. Furthermore, the battery unit 10 comprises a housing element 20. The housing element 20 forms a recess 26, into which a bar 24 of the light guiding element 16 fits. Thus, beams of light may emanate from the lighting element 14, which are guided to the external surface of the battery unit 10 by way of the bar 24. Further preferably, the battery unit 10 comprises a side surface 34. In particular, in a first section 28, the light guiding element 16 covers a button element 18. The button element 18 can be deflected towards the side surface 34 when a force 40 acts on the light guiding element 16. As shown in FIG. 3, the light guiding element 16 deflects to actuate the button element 18. Further preferably, the light guiding element 16 comprises a second section 30, which covers the lighting element 14. The first section 28 can be arranged with respect to the second section 30 such that it forms a pretensioning force 38 in the direction of the side surface 34.

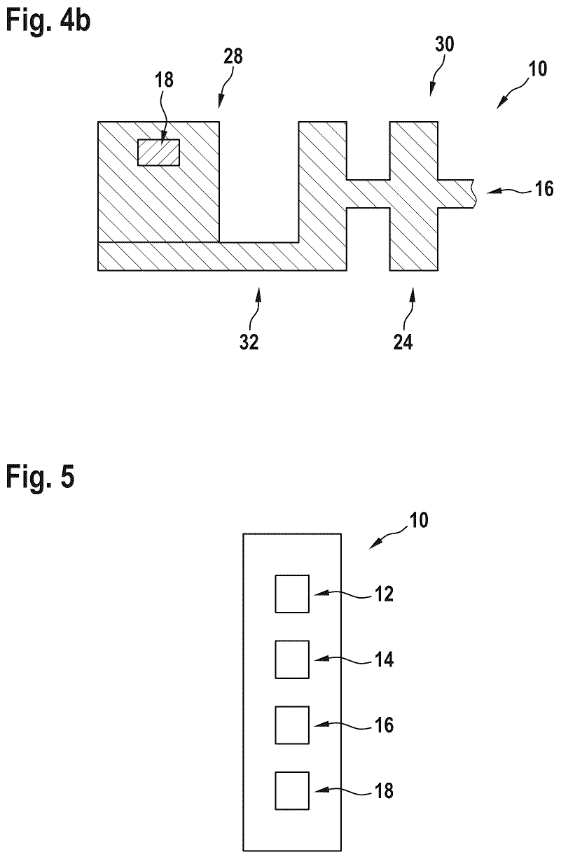

FIG. 4a shows a battery unit 10 according to one embodiment. The light guiding element 16 comprises a first section 28. The first section 28 is arranged on the second section 30 by way of a deflector element 32. The deflector element 32 is configured such that a force 40 acts on the first section 28 such that the first section 28 of the light guiding element 16 is deflected or is in a deflected state 42 to actuate the button element 18. The deflected state 42 of the light guiding element 16 can in particular be defined by a stop element 22. Further preferably, stop element 22 is positioned such that when force 40 acts on the first section 28, the button element 18 is actuated, but the deflection 42 is limited to a predetermined amount.

FIG. 4b shows a battery unit 10 according to one embodiment. The battery unit 10 comprises a light guiding element 16. The light guiding element 16 comprises a bar 24, which is configured to transport light beams from a lighting element 14 to a side surface 34 of the battery unit 10. Further preferably, the light guiding element 16 comprises a first section 28, which is arranged over a button element 18. Further preferably, the light guiding element 16 comprises a second section 30, which is arranged over a lighting element 14. Further preferably, the first section 28 and the second section 30 are connected to each other by way of a deflector element 32.

FIG. 5 shows the battery unit 10 according to one embodiment. The battery unit 10 comprises a circuit board element 12. Furthermore, the battery unit 10 comprises a lighting element 14, which is configured to display a charge state of the battery unit 10. Furthermore, the battery unit 10 comprises a light guiding element 16 and a button element 18. The lighting element 14 is arranged on the circuit board element, wherein the light guiding element 16 is in contact with the lighting element 14 in order to guide a beam of light emanating from the lighting element 14. Furthermore, the button element 18 is arranged on the circuit board element 12. In addition, the light guiding element 16 is arranged to guide a force 40 acting on the light guiding element 16 to the button element 18 by way of a shape change of the light guiding element 16.

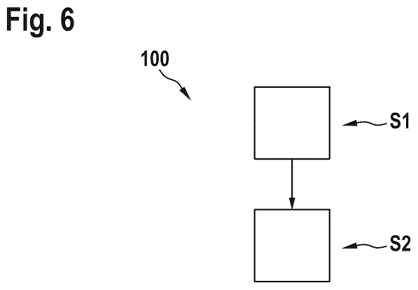

FIG. 6 shows a flow chart illustrating the steps of method 100 according to one embodiment. Method 100 of manufacturing a battery unit 10, as described above and below, comprises the steps of:
providing S1 of a light guiding element 16,
arranging S2 the light guiding element 16 on the battery unit 10,
   wherein the arrangement of the light guiding element 16 forms a substantially fluid-tight and/or particulate-tight connection between the light guiding element 16 and the battery unit 10, and the light guiding element 16 provides a cover for a button element 18 of the battery unit 10.

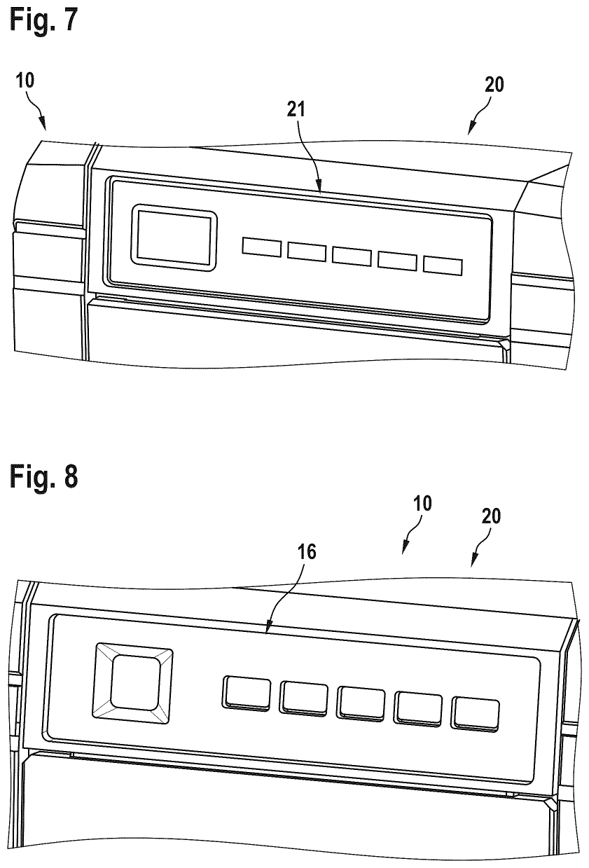

FIG. 7 shows one embodiment of the battery unit 10. The battery unit 10 comprises a housing element 20. As shown in FIG. 7, a cover 21 is located over the light guiding element 16.

FIG. 8 shows a battery unit 10 according to one embodiment. The battery unit 10 comprises a housing element 20. Preferably, the light guiding element 16 is arranged in a force-fitting and/or interlocking manner on the housing element 20 so that no fluid or similar can intrude into the battery unit 10 from the outside.

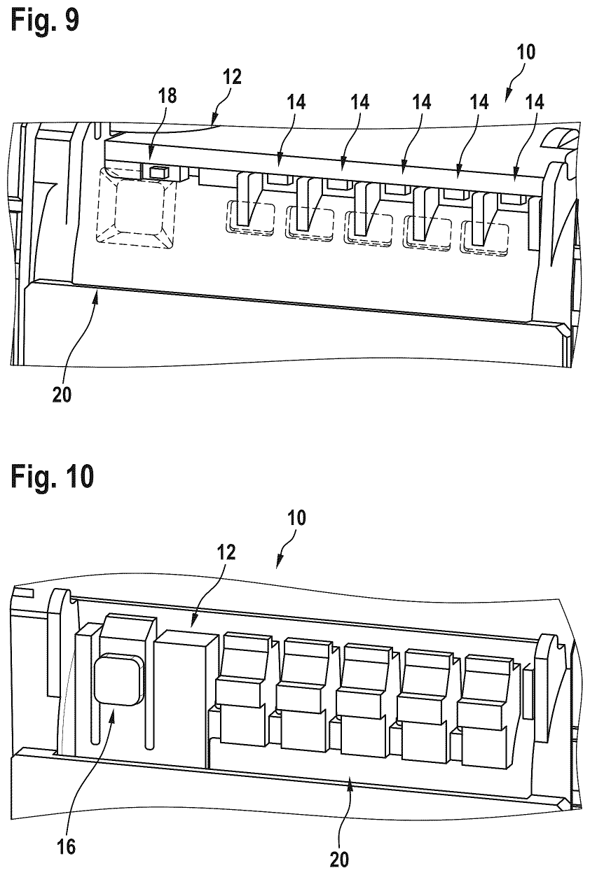

FIG. 9 shows one embodiment of the battery unit 10. The battery unit 10 comprises a circuit board element 12, a plurality of lighting elements 14 and a button element 18. Furthermore, the battery unit 10 comprises a housing element 20. The housing element 20 is at least partially transparently configured as shown in FIG. 9.

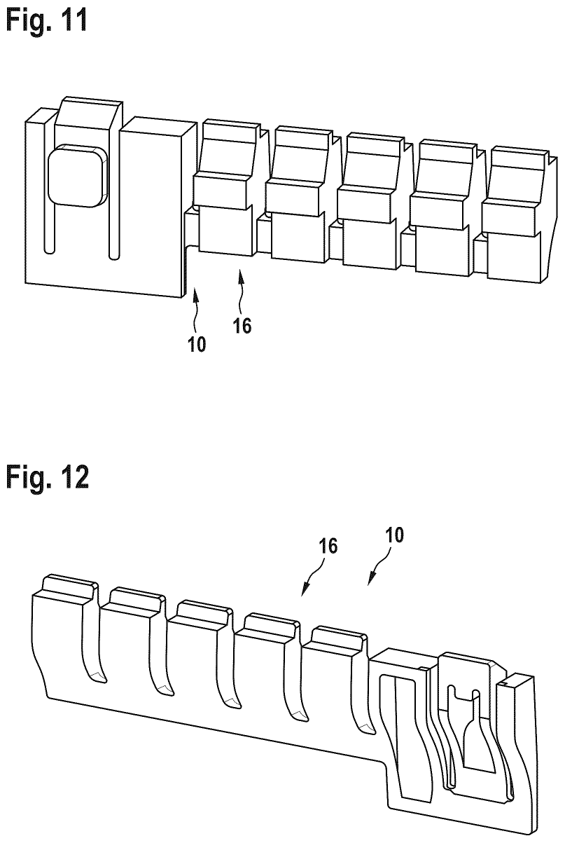

FIG. 10 shows one embodiment of the battery unit 10. The battery unit 10 preferably comprises a circuit board element 12, over which the light guiding element 16 is located. Furthermore, the circuit board element 12 and the light guiding element 16 are located on the housing element 20 of the battery unit 10.

FIG. 11 shows one embodiment of the battery unit 10. The battery unit 10 comprises a light guiding element 16.

FIG. 12 shows a battery unit 10 according to one embodiment. The battery unit 10 comprises a light guiding element 16.

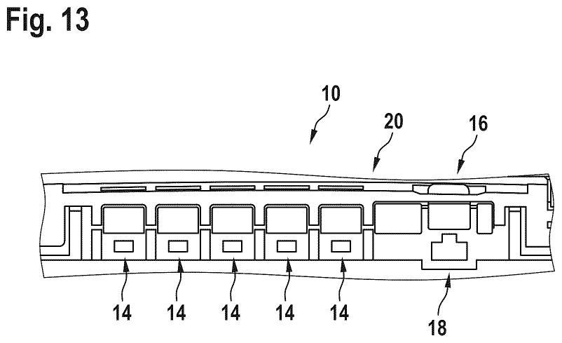

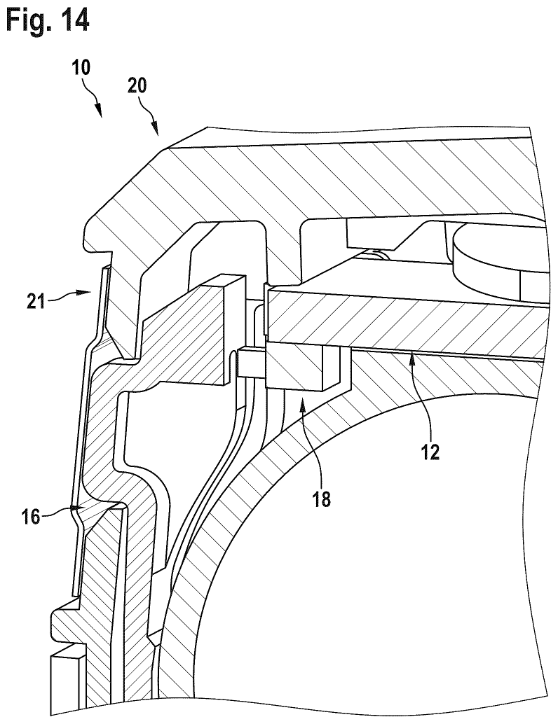

FIG. 13 shows a battery unit 10 according to one embodiment. Preferably, the battery unit 10 comprises a plurality of lighting elements 14 as well as a button element 18. A light guiding element 16 of the battery unit 10 is arranged over the lighting elements 14 and the button element 18. In particular, the light guiding element 16 can project at least partially from the housing element 20 of the battery unit 10 in order to be able to at least partially press the light guiding element 16 against the button element 18.

FIG. 14 shows a battery unit 10 according to one embodiment. The battery unit 10 preferably comprises a housing element 20. The housing element 20 at least partially encloses a light element 16, a button element 18 and a circuit board element 12. The light guiding element 16 can be at least partially covered by a cover 21. Preferably, the cover 21 is set on the housing element 20.

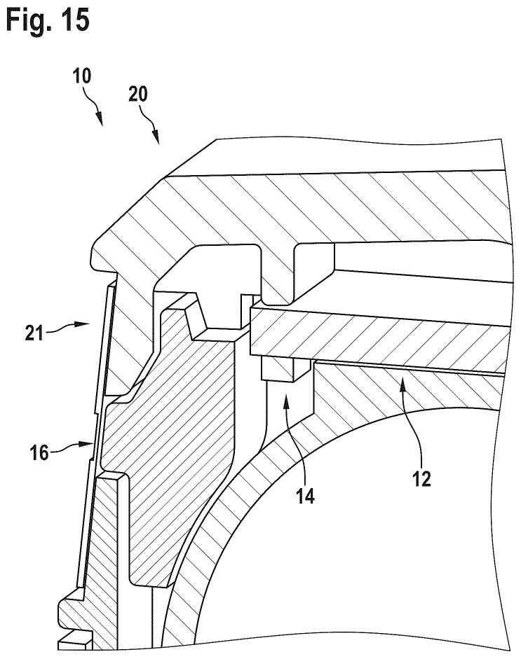

FIG. 15 shows a battery unit 10 according to one embodiment. The battery unit 10 comprises a circuit board element 12 and a lighting element 14 above which the light guiding element 16 is located. Furthermore, the housing element 20 at least partially encloses the light guiding element 16. Further preferably, the light guiding element 16 is covered with a cover 21.

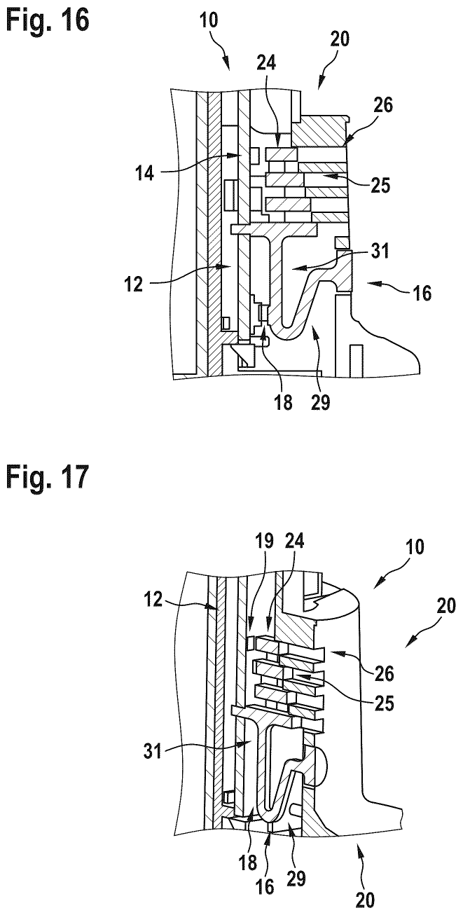

FIG. 16 shows one embodiment of the battery unit 10. The battery unit 10 preferably comprises a circuit board element 12, a lighting element 14 and a button element 18. Preferably, the light guiding element 16 is arranged over the lighting element 14 and the button element 18. Preferably, the light guiding element 14 comprises a first bar 24, which engages a recess 26 of the housing element 20. Further preferably, the light guiding element 16 comprises a further bar 25, wherein the further bar 25 has a lower longitudinal extension direction than the bar 24, such that the light guiding element 16 is insertable between the lighting element 14 and the housing element 20. Further preferably, the light guiding element 16 comprises a first segment 29 and a second segment 31, wherein the first segment 29 abuts the button element 18 and the housing element 20, wherein the second segment 31 is configured to provide a deflection of the first segment 29. Further preferably, the second segment 31 has a curved longitudinal extension direction to provide a spring effect for the first segment 29.

FIG. 17 shows one embodiment of the battery unit 10. FIG. 17 shows a perspective view of the battery unit 10 as already described in FIG. 16.

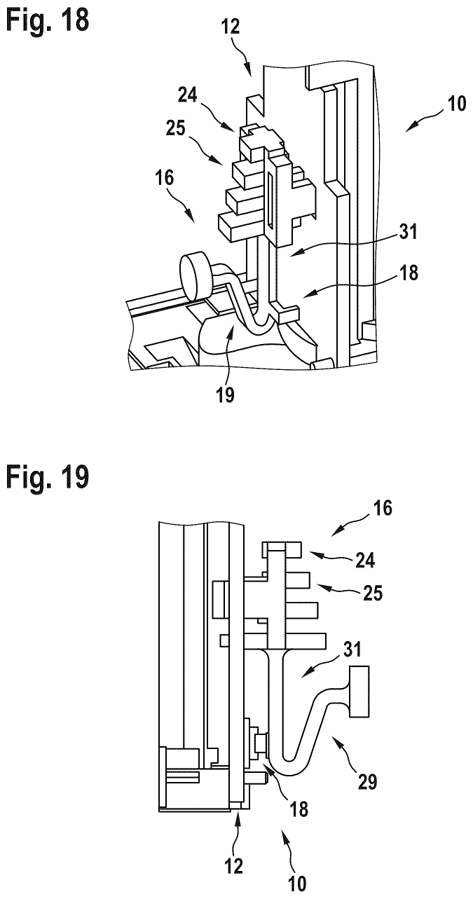

FIG. 18 shows one embodiment of the battery unit 10. The battery unit 10 preferably comprises a circuit board element 12 on which a button element 18 is arranged. The first segment 29 of the light guiding element 16 is preferably abutting the button element 18.

Further preferably, the second segment 31 of the light guiding element 16 may deflect the first segment 29 to the button element 18. Further preferably, the light guiding element 16 comprises a bar 24 and a further bar 25.

FIG. 19 shows one embodiment of the battery unit 10. FIG. 19 shows a battery unit 10 with a similar configuration in a side view, as already described in FIG. 18.

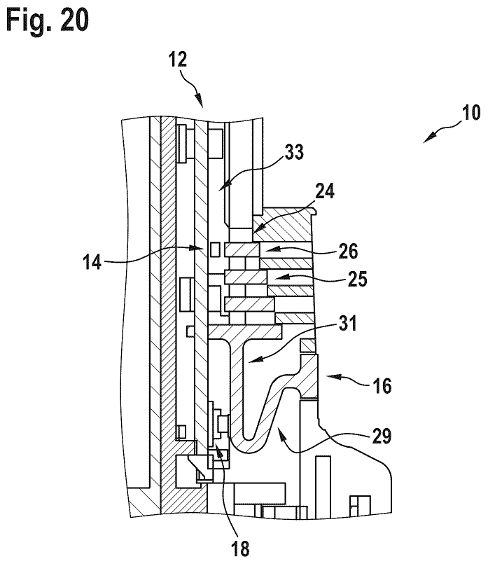

FIG. 20 shows one embodiment of the battery unit 10. The battery unit 10 comprises a circuit board element 12 on which a lighting element 14 and a button element 18 are arranged. The light guiding element 16 is arranged over the lighting element 14 and the button element 18. An auxiliary light guide 33 may be located between the light guiding element 16 and the circuit board element 12. In particular, the auxiliary light guide 33 can convey a beam of light from the lighting element 14 to the light guiding element 16.

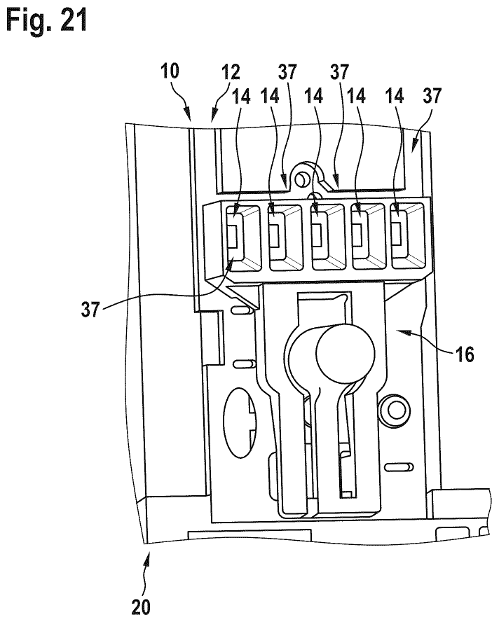

FIG. 21 shows one embodiment of a battery unit 10. The battery unit 10 comprises a circuit board element 12, upon which a plurality of lighting elements 14 are arranged. A light guiding element 16 is arranged over the lighting elements 14. The circuit board element 12 and the light guiding element 16 are preferably arranged on the housing element 20. The light guiding element 16 may form a type of ring 37 around the lighting element 14. The light guiding element 16 can thus guide the light, on the one hand, as well as guide reflections to the external surface of the housing elements 20.

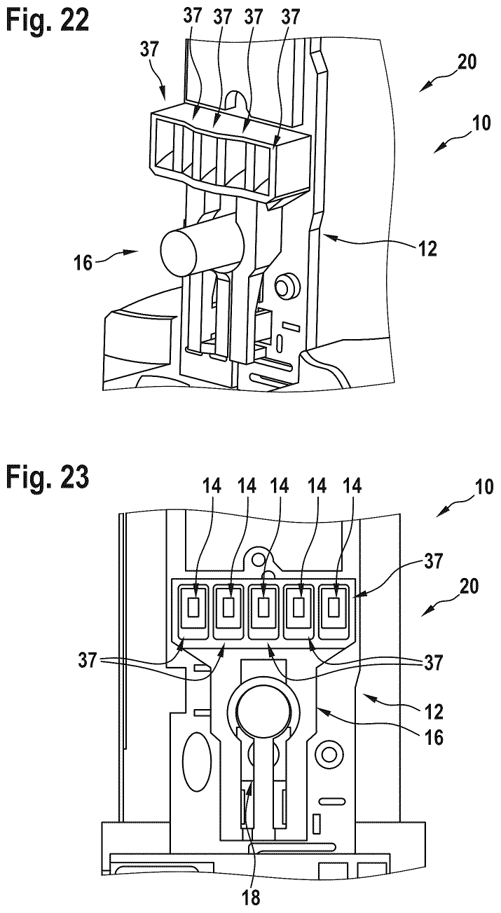

FIG. 22 shows a battery unit 10 according to one embodiment. Preferably, the battery unit 10 comprises a light guiding element 16 having a plurality of rings 37 around respective light elements 14.

FIG. 23 shows one embodiment of the battery unit 10. The battery unit 10 comprises a circuit board element 12, upon which a button element 18 and a plurality of lighting elements 14 are arranged. A light guiding element 16 is arranged over the lighting element 14 and the button element 18. Preferably, the light guiding element 16 forms a plurality of rings 37, in particular around each of the lighting elements 14.

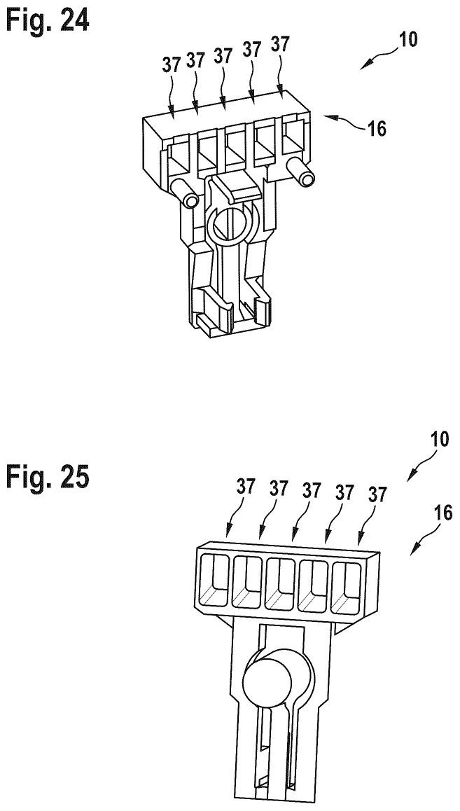

FIG. 24 shows one embodiment of the battery unit 10. The battery unit 10 preferably comprises a light guiding element 16 having a plurality of rings 37.

FIG. 25 shows one embodiment of the battery unit 10. The battery unit 10 comprises a light guiding element 16 with a plurality of rings 37.

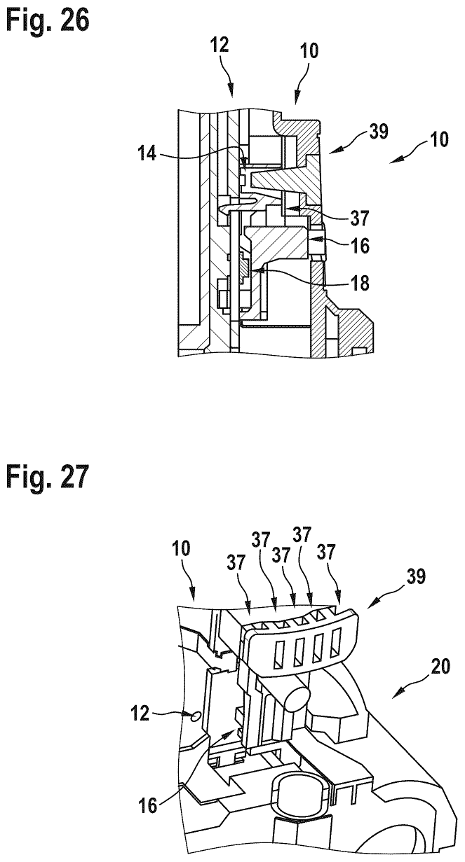

FIG. 26 shows a battery unit 10 according to one embodiment. The battery unit 10 preferably comprises a circuit board element 12, upon which a lighting element 14 and a button element 18 are arranged. The light guiding element 16 is arranged above the lighting element 14 and the button element 18 and it forms a ring 37 around the lighting elements 14. Preferably, a plug-in light guide 39 may be arranged in the ring 37. Thus, both reflections through the rings 37 and the direct light through the plug-in light guide 39 can be transported from the lighting element 14 to the external surface of the housing element 20.

FIG. 27 shows one embodiment of the battery unit 10. The battery unit 10 preferably comprises a circuit board element 12, upon which a light guiding element 16 is arranged. Preferably, the circuit board element 12 and the light guiding element 16 are arranged on the housing element 20. Preferably, the light guiding element 16 comprises a plurality of rings 37, in which a plug-in light guide 39 can be arranged.

What is claimed is:

1. A battery unit, comprising:
a circuit board element;
a lighting element configured to display a charge state of the battery unit;
a light guiding element; and
a button element,
wherein the lighting element is arranged on the circuit board element,
wherein the light guiding element is in contact with the lighting element to guide a beam of light starting from the lighting element,
wherein the button element is arranged on the circuit board element, and
wherein the light guiding element is configured to guide a force acting on the light guiding element to the button element by way of changing the shape of the light guiding element.

2. The battery unit according to claim 1, wherein the light guiding element is configured to actuate the button element with a predetermined force.

3. The battery unit according to claim 1, wherein:
the battery unit comprises a housing element, and
the light guiding element is configured to form a substantially fluid-tight and/or particulate-tight connection with the housing element.

4. The battery unit according to claim 3, wherein:
the housing element, the button element and/or the light guiding element comprise a stop element, and
the stop element is configured to limit the shape change of the light guiding element.

5. The battery unit according to claim 3, wherein the light guiding element comprises at least one bar that engages a recess of the housing element to provide the substantially fluid-tight and/or particulate-tight connection.

6. The battery unit according to claim 5, wherein:
the light guiding element comprises a further bar, and
the further bar has a lower longitudinal extension direction than the bar, such that the light guiding element is insertable between the lighting element and the housing element.

7. The battery unit according to claim 1, wherein:
the light guiding element comprises a first segment and a second segment,
the first segment abuts the button element and the housing element, and
the second segment is configured to provide a deflection of the first segment.

8. The battery unit according to claim 7, wherein the second segment has a curved longitudinal extension direction to provide a spring effect for the first segment.

9. The battery unit according to claim 1, wherein:
the light guiding element comprises a first section and a second section,
the first section is located at least partially over the button element,
the second section is located at least partially over the lighting element, and
only the first section is configured to provide the shape change of the light guiding element.

10. The battery unit according to claim 9, wherein the first section is deflectable to the second section such that the second section is arranged substantially in a stationary manner with respect to the lighting element and the first section provides the shape change of the light guiding element.

11. The battery unit according to claim 9, wherein:
the light guiding element comprises a deflector element arranged between the first section and the second section, and
the deflector element is configured to deflect the first section to the second section to provide the shape change of the light guiding element.

12. The battery unit according to claim 9, wherein the first section and the second section are arranged with respect to one another such that the first section is configured to form a pretensioning force against at least one side surface of the battery unit.

13. The battery unit according to claim 1, wherein the light guiding element is configured to form at least one ring around the lighting element to guide the light.

14. A method for producing a battery unit according to claim 1, comprising:
providing a light guiding element; and
arranging the light guiding element on the battery unit,
wherein the arrangement forms a substantially fluid-tight and/or particulate-tight connection between the light guiding element and the battery unit, and the light guiding element provides a cover for a button element of the battery unit.

15. A use of a battery unit according to claim 1 for power supply.
